(19) United States
(12) Patent Application Publication
(10) Pub. No.: US 2007/0068335 A1
(43) Pub. Date: Mar. 29, 2007

(54) INTEGRALLY MOLDED COMPOSITE STEERING WHEELS

(76) Inventors: Eric Jon Jaarda, Milan, MI (US); Mike Mahfet, Rochester Hills, MI (US); Manish Chaturvedi, Farmington, MI (US); Scott Purks, North Branch, MI (US)

Correspondence Address: GEAM - 08CT;IP LEGAL, ONE PLASTICS AVENUE, PITTSFIELD, MA, 01201-3697, US

(21) Appl. No.: 11/467,266

(22) Filed: Aug. 25, 2006

Related U.S. Application Data
(63) Continuation-in-part of application No. 11/213,544, filed on Aug. 26, 2005.

(51) Int. Cl. B62D 1/04; G05G 1/10

(52) U.S. Cl. 74/552

(57) ABSTRACT

A composite steering wheel for an automotive vehicle having a steering column is provided. In an exemplary embodiment, the composite steering wheel includes a rim, a center hub, and a plurality of spokes connecting the rim to the center hub. The rim, the center hub, and the plurality of spokes are formed from a deformable thermoplastic material. The rim, the center hub, and the plurality of spokes may be formed from a single thermoplastic piece or may be formed from two thermoplastic pieces joined to one another. The composite steering wheel also includes an attachment member embedded in the center hub. The attachment member is sized to couple to the steering column.

### CROSS REFERENCE TO RELATED APPLICATIONS

This application is a continuation-in-part application of U.S. Ser. No. 11/213,544, which was filed Aug. 26, 2005.

### BACKGROUND OF THE INVENTION

This invention relates generally to steering wheels for automotive vehicles, and more particularly to integrally molded composite steering wheels including a deformable thermoplastic material.

Known steering wheels include a metal armature that forms the spokes, the rim, and the hub of the steering wheel. The armature is usually fabricated as a single piece or formed from separate parts that are welded or joined together with fasteners. The armature is encapsulated by an appropriate covering material such as wood, elastomeric materials, for example, polyurethane materials, or a combination of materials.

Disadvantages of known metal armatures are their relatively heavy weight and their high mass moment inertia. Further, the use of polyurethane materials can create work place environmental issues as well as worker safety issues. Also, because of the need to increase fuel economy of automobiles, weight reduction is an important aspect of automotive design. And as such the relatively heavy weight of known metal armatures needs to be overcome.

### BRIEF DESCRIPTION OF THE INVENTION

The present invention provides a composite steering wheel for an automotive vehicle having a steering column. The composite steering wheel includes a rim, a center hub, and a plurality of spokes connecting the rim to the center hub. The rim, the center hub, and the plurality of spokes are formed from a deformable thermoplastic material. The rim, the center hub, and the plurality of spokes may be formed from a single thermoplastic piece or may be formed from two thermoplastic pieces joined to one another. The composite steering wheel also includes an attachment member embedded in the center hub with the attachment member being sized to couple to the steering column of the vehicle.

In one aspect, a composite steering wheel for an automotive vehicle having a steering column is provided. The composite steering wheel includes a rim, a center hub, and a plurality of spokes connecting the rim to the center hub. The rim, the center hub and the plurality of spokes are formed from a deformable thermoplastic material. The composite steering wheel also includes an attachment member embedded in the center hub. The attachment member is sized to couple to the steering column.

In another aspect, a method of forming a composite steering wheel for an automotive vehicle having a steering column is provided. The method includes providing an attachment member sized to couple to the steering column, positioning the attachment member in the mold, and introducing a deformable thermoplastic material into the mold to form a rim, to form a center hub with the attachment member embedded therein, and to form a plurality of spokes connecting the rim to the center hub.

In yet another aspect, a composite steering wheel for an automotive vehicle having a steering column is provided. The composite steering wheel includes a rim, a center hub, and a plurality of spokes connecting the rim to the center hub. The rim, the center hub and the plurality of spokes are formed from a deformable thermoplastic material and are formed from two thermoplastic pieces that are joined to one another. The composite steering wheel also includes an attachment member embedded in the center hub. The attachment member is sized to couple to the steering column.

### BRIEF DESCRIPTION OF THE DRAWINGS

FIG. 1 is a perspective schematic illustration of a composite steering wheel in accordance with an embodiment of the present invention.

FIG. 2 is a perspective exploded schematic illustration of the composite steering wheel shown in FIG. 1 including vibration dampers.

FIG. 3 is a sectional schematic illustration of a portion of the composite steering wheel shown in FIG. 2.

FIG. 4 is a perspective exploded schematic illustration of a composite steering formed from two pieces according to an alternative embodiment of the present invention.

### DETAILED DESCRIPTION OF THE INVENTION

The present invention is more particularly described in the following description and examples that are intended to be illustrative only since numerous modifications and variations therein will be apparent to those skilled in the art. As used in the specification and in the claims, the term “comprising” may include the embodiments “consisting of” and “consisting essentially of.” All ranges disclosed herein are inclusive of the endpoints and are independently combinable. The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value.

The present invention provides a composite steering wheel formed from a deformable thermoplastic material that in one embodiment is over-molded around a metal or plastic rim element is described below in detail. In another embodiment the composite steering wheel does not include a rim element. In yet another embodiment, the composite steering wheel includes a thermoplastic material that is formed in one piece. In still another embodiment, the composite steering wheel includes a thermoplastic material that is formed in a two-piece “clamshell” design. In yet another embodiment a metal or plastic rim element is located between and attached to the two pieces of a composite steering wheel.

The composite steering wheel includes vibration dampers located in the spokes of the steering wheel. Metal or plastic inserts in the rim and center hub permit the steering wheel to withstand occupant impact loads and to permanently deform to absorb energy and prevent “rebound” of the steering wheel back to the occupant during an impact event.

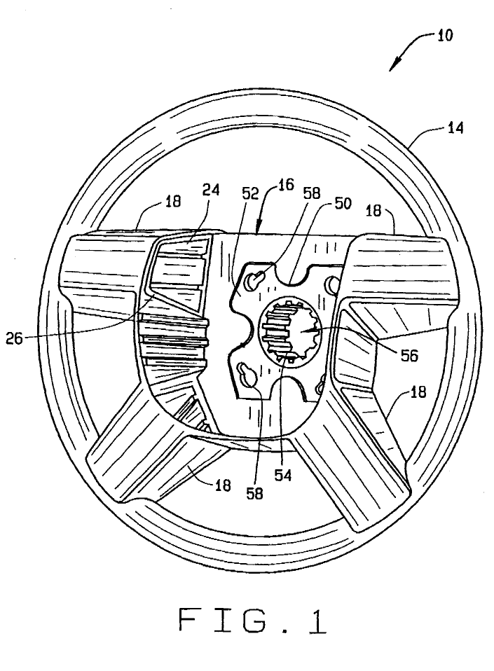

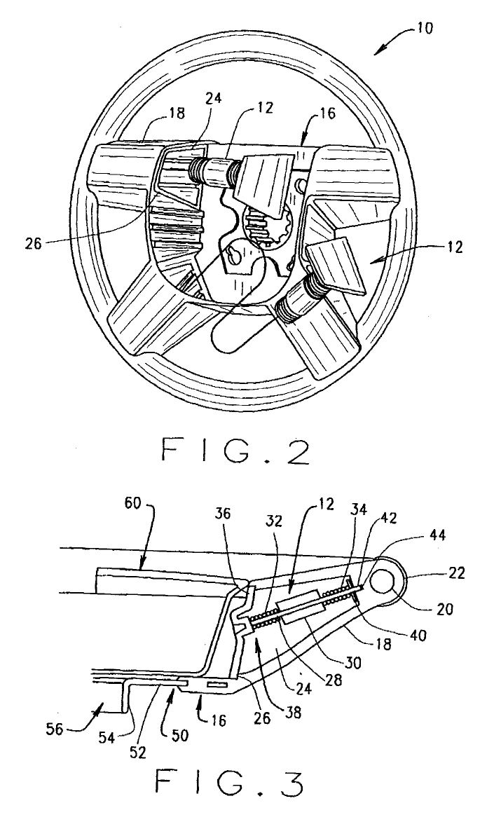

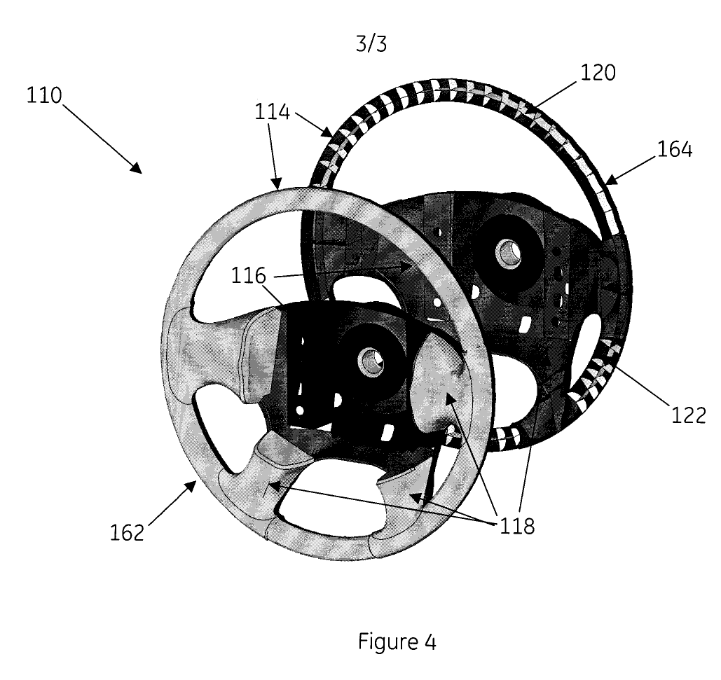

Referring to the drawings, FIG. 1 is a perspective schematic illustration of one embodiment of a composite steering wheel 10. FIG. 2 is a perspective schematic illustration of composite steering wheel 10 including vibration dampers 12, and FIG. 3 is a section al schematic illustration of a portion of composite steering wheel 10. FIG. 4 is an exploded view of a two-piece “clamshell” composite steering wheel.

Referring to FIGS. 1-3, the composite steering wheel 10 includes a rim 14, a center hub 16, and a plurality of spokes 18 (4 shown) connecting rim 14 to center hub 16. Rim 14 is formed from a metal or plastic rim element 20 over-molded with a deformable thermoplastic material 22. In the exemplary embodiment, rim element 20 is a metal or plastic rod that has a circular cross section. In another embodiment, rim element 20 is a hollow tubular element. Also, in alternate embodiments, rim element 20 has a rectangular or a polygonal cross sectional shape. Any suitable metal can be used to form rim element 20, including, but not limited to, steel, aluminum, and magnesium. Also, any suitable plastic material can be used to form rim element 20, for example, silicone modified polycarbonates, nylon, polyesters, polyphenylene oxide, polypropylene, and polyurethane. Particularly, rim element 20 can be solid or hollow polymeric material. Water assist, gas assist, rotational molding, or other methodologies employed to achieve hollow sections in polymeric materials, can be used to achieve a hollow core. Also, the material can be foamed to introduce minute gas pockets dispersed throughout the core of the material of rim element 20. Various methods, including but not limited to, exothermic blowing agents, introduction of liquid nitrogen or nitrogen gas during the melt phase of processing, or other such methods can be used to accomplish the foaming. In an alternate embodiment, rim 14 is formed from thermoplastic 22 without the presence of rim element 20.

Spokes 18 and center hub 16 are formed from thermoplastic material 22, and, in this embodiment, are molded as one piece along with rim 14. Particularly, metal rim element 20 is positioned in a mold and thermoplastic material 22 is introduced into the mold so that thermoplastic material 22 forms spokes 18, center hub 16 and over-molds metal rim element 20 to form rim 14 with metal rim element 20 embedded in thermoplastic material 22. Any suitable molding technique can be used, for example injection molding. A suitable thermoplastic material 22 is deformable and absorbs energy during an impact event. Specifically, a suitable thermoplastic material has the properties of elastic deformation at low loads and plastic deformation at high loads. Low loads being characterized as those encountered during normal operation of a steering wheel, and high loads being characterized as severe abuse or impact events as defined under Federal Motor Vehicle Safety Standard 203. Further, thermoplastic material 22 has a 20 percent stress to failure rating as measured by tensile testing in accordance with ASTM D-638. Examples of suitable thermoplastic materials 22 include, but are not limited to, silicone modified polycarbonate, nylon, polyesters, polyphenylene oxide, polypropylene, mixtures thereof, and foamed materials thereof. In the exemplary embodiment, silicone modified polycarbonate, commercially available from the General Electric Company under the trademark LEXAN® EXL, is used.

Each spoke 18 includes a hollow cavity 24 extending from center hub 16 to rim 14. Cavity 24 includes an access opening 26 adjacent center hub 16. Cavity 24 is sized to receive vibration damper 12 which includes a center rod 28, a weight (mass) 30 slidably coupled to center rod 28, a first spring 32 and a second spring 34. First and second springs 32 and 34 are positioned on opposite sides of weight 30. Vibration damper 12 also includes a first end cap 36 attached to first end 38 of center rod 28 that is sized to close opening 26 in cavity 24. A second end cap 40 is attached to second end 42 of center rod 28 and anchors second spring 34 to prevent second spring from moving past second end 42 of center rod 28. Second end 42 of center rod 28 is positioned in a bore 44 in the inner wall defining cavity 28 adjacent rim 14.

A flat or formed metal plate 50 is molded into center hub 18. Metal plate 50 includes a flat portion 52 and a center attachment portion 54 extending from flat portion 52 and through center hub 18. Attachment portion 54 includes an attachment bore 56 extending there through that is sized and shaped to receive the steering column (not shown) of an automobile vehicle to attach composite steering wheel 10 to the steering column. Flat portion 52 also includes a plurality of airbag attachment openings 58 that are sized for attachment of an airbag unit 60 to center hub 18 between spokes 16. Metal plate 50 acts as a reaction plate for airbag unit 60 during deployment of the airbag in an impact event. In one embodiment, flat portion 52 and attachment portion 54 are formed as a single piece. In another embodiment, attachment portion 54 is a separate piece that is attached to flat portion 52 by any suitable method, for example, by welding, spin welding, swaging, cold heading, and the like. In an alternate embodiment, composite steering wheel includes an attachment sleeve that does not include a flat plate portion. The attachment sleeve is embedded in the thermoplastic material and sized and shaped to receive the steering column of an automotive vehicle. Metal plate 50 can be formed from any suitable metal, for example, steel, aluminum, and magnesium.

FIG. 4 provides a composite steering wheel 110 similar to the one depicted in FIGS. 1-3 and wherein the steering wheel includes a rim 114, a center hub 116, and a plurality of spokes 118 connecting the rim 114 to center hub 116. As with the one-piece embodiment, rim 114 is formed from a metal or plastic rim element 120 over-molded with a deformable thermoplastic material 122. Alternatively, the rim element 120 may be placed between the two separate pieces 162, 164 and attached to each piece 162, 164 such that the rim element 120 is not overmolded but molded between the two pieces 162, 164. Also, rim element 120 can be a metal or plastic rod that has a circular, rectangular or a polygonal cross sectional shape and/or may be a hollow tubular element. Any suitable metal or plastic material can be used to form rim element 120 and rim element 120 may be formed using one or more of the methods previously described.

As with the one piece embodiment, spokes 118 and center hub 116 are formed from thermoplastic material 122, and, in this embodiment, are molded as two separate pieces 162, 164 using any suitable molding technique such as injection molding. After being formed, the two pieces are joined to one another using any technique capable of joining thermoplastic materials to one another, such as adhesives, welding (e.g. sonic welding), or a combination of techniques.

As discussed, the two pieces 162 and 164 may be formed using a suitable thermoplastic material 122 that is deformable and absorbs energy during an impact event. As previously described, a suitable thermoplastic material has the properties of elastic deformation at low loads and plastic deformation at high loads. Low loads being characterized as those encountered during normal operation of a steering wheel, and high loads being characterized as severe abuse or impact events as defined under Federal Motor Vehicle Safety Standard 203. Further, thermoplastic material 22 has a 20 percent stress to failure rating as measured by tensile testing in accordance with ASTM D-638. The two pieces 162 and 164 are, in one embodiment, formed using the same thermoplastic materials. In an alternative embodiment, the two pieces 162 and 164 are formed using two different thermoplastic materials. The use of two different thermoplastic materials enables the design of the steering wheel to be structured based on selected design criteria.

As with the embodiment set forth in FIGS. 1-3, each spoke 118 includes a hollow cavity 124 extending from center hub 116 to rim 114. Each cavity 124 includes an access opening 126 adjacent the center hub 116 with each cavity 24 is sized to receive a vibration damper. A flat or formed metal plate 150 is molded into center hub 118. The metal plate 150 includes a flat portion 152 and a center attachment portion 154 extending from flat portion 152 and through the center hub 118. The attachment portion 154 includes an attachment bore 156 extending there through that is sized and shaped to receive the steering column (not shown) of an automobile vehicle to attach composite steering wheel 110 to the steering column. In an alternate embodiment, composite steering wheel 110 includes an attachment sleeve that does not include a flat plate portion 152. Instead, the attachment sleeve is embedded in the thermoplastic material and sized and shaped to receive the steering column of an automotive vehicle.

While typical embodiments have been set forth for the purpose of illustration, the foregoing descriptions should not be deemed to be a limitation on the scope of the invention. Accordingly, various modifications, adaptations, and alternatives may occur to one skilled in the art without departing from the spirit and scope of the present invention.

What is claimed is:

1. A composite steering wheel for an automotive vehicle, the automotive vehicle having a steering column, the composite steering wheel comprising:
a rim;
a center hub;
a plurality of spokes connecting the rim to the center hub; and
an attachment member embedded in the center hub, the attachment member sized to couple to the steering column;
wherein the rim, the center hub, and the plurality of spokes comprise a deformable thermoplastic material and wherein the rim, the center hub, and the plurality of spokes are formed from two thermoplastic pieces joined to one another.

2. A composite steering wheel in accordance with claim 1 wherein the deformable thermoplastic material is a foamed thermoplastic material.

3. A composite steering wheel in accordance with claim 1, wherein the rim comprises a rim element, the deformable thermoplastic material overmolded around the rim element.

4. A composite steering wheel in accordance with claim 3 wherein the rim element comprises a metal material or a plastic material, the metal material comprising at least one of steel, aluminum, and magnesium, the plastic material comprising at least one of silicone modified polycarbonates, nylon, polyesters, polyphenylene oxide, polypropylene, and polyurethane.

5. A composite steering wheel in accordance with claim 3 wherein the rim element is solid or tubular and comprises a circular, rectangular, or polygonal cross sectional shape.

6. A composite steering wheel in accordance with claim 1 wherein the deformable thermoplastic material comprises at least one of silicone modified polycarbonates, nylon, polyesters, polyphenylene oxide, polypropylene, and foamed thermoplastic materials thereof.

7. A composite steering wheel in accordance with claim 1 wherein the deformable thermoplastic material further comprises a plurality of reinforcing fibers.

8. A composite steering wheel in accordance with claim 1 wherein the thermoplastic material has a 20 percent stress to failure rating as measured by ASTM D638.

9. A composite steering wheel in accordance with claim 1 wherein at least one the spoke comprises a hollow chamber extending from the hub at least partially to the rim.

10. A composite steering wheel in accordance with claim 9 further comprising a vibration damper assembly positioned in each the hollow chamber.

11. A composite steering wheel in accordance with claim 10 wherein the vibration damper assembly comprises:
a center rod;
a weight slidably coupled to the center rod;
a first spring positioned over the rod between the weight and a first end of the rod;
a second spring positioned over the rod between the weight and a second end of the rod;
a first end cap coupled to the first end of the rod; and
a second end cap coupled to the second end of the rod.

12. A composite steering wheel in accordance with claim 1 wherein the attachment member comprises:
a plate portion;
an attachment portion extending from one side of the plate portion; and
an attachment opening extending through the attachment portion, the attachment opening sized to receive the steering column.
